(19) United States
(12) Patent Application Publication
(10) Pub. No.: US 2009/0024921 A1
(43) Pub. Date: Jan. 22, 2009

(54) Methods for processing of multimedia information, systems therefore and methods of the assigned area definition.

(76) Inventors: Aleksander BELENOV, Moscow (RU); Sergey Mayorov, Moscow Reg. (RU); Ruslan Kaftanatiy, Sankt-Peterburg (RU)

Correspondence Address: Sergey PLATONOV, P.O. Box#341, 16-07 Lomonosova str. , Zhukovsky-1, Moscow, 140181, RU

(21) Appl. No.: 11/751,022

(22) Filed: May 20, 2007

(30) Foreign Application Priority Data
Dec. 29, 2004 (RU) 2004138685A1
Mar. 21, 2005 (RU) PCT/RU05/00125

(51) Int. Cl. G06F 3/00

(52) U.S. Cl. 715/716

(57) ABSTRACT

A method of multimedia (video, graphic, audio etc) data processing, comprises assignment of an area in the demonstration medium for receiving viewer's commands during the multimedia information demonstration process, for linking external applications, currently executed application, for an external application data placement and/or the results of work thereof. If the demonstration medium does not have a graphical representation, the assigned area is defined as a set of parameters, an interval of parameters, a group of parameters. A multimedia application of any type as well as the results of work thereof can be placed into the assigned area. A method for the formation in the demonstration medium contours of the assigned area which tracing an object of a complex shape in the displayed image, comprises the assigned area formation by one or more piecewise smooth arcs, adjusted to achieve the best coincidence with the contours of the traced object.

The field of the present invention relates generally to a multimedia processing and particularly to the interactively operated video applications such as interactively operated video guides or video excursions to cities, museums, exhibitions, restaurants, video manuals, video advertisements etc.

Term “multimedia”, as used in the present document, is a particular tool on the base of computer technologies, allowing to use a plurality of information areas: video, graphic, text, photo, animation, audio effects, audio accompaniment and corresponding tools—simultaneously and/or separately.

Video guide (“action” is more habitual definition for game amateurs) is not only the beautiful travel, in space and about time, to city, restaurant, museum, etc, it gives the opportunity of real control of the travel, as well. In addition to passive contemplation of city sights (for example), a viewer can show activity, in the process of viewing a video guide: change the direction of city survey, learn the history of street's name, learn other details etc., obtain additional necessary information concerning any object occurring on the way.

To obtain information a view should choose an active point or item on the demonstration medium (screen) commonly with the help of manipulator—“mouse” or the like. A video image or a part thereof may be assigned as an active point or item. The active item can be marked out at demonstration medium by “mouse” cursor or via popup window with text message. The text message may contain the active item name, as along with tool tip or instruction what to do. The presence of the active item on the screen can be accompanied by the appearance of markers, representing a arbitrary picture. The markers attract viewer's attention to the active item during the video guide viewing process. Scripts are preliminarily created to make visual patterns active. Every script represents a set of tools and the episodes playback consecution, written in special language. It is the script that defines any additional information, available to a viewer after the item (or the point) activation.

The presence of scripts is the main feature that distinguish the above mentioned video guides from ordinary films. It is the script that controls playback of video guides at a playback device. A viewer can obtain additional data about items displayed. This data may contain:
a hyperlink,
a text message in transparent windows,
a video clip or a picture demonstration in different window,
an external document opened in transparent windows, i.e. documents with extension *.doc, *.pdf etc.,
a sound accompaniment,
sound effects,
an animation.

On the whole, video guide may be composed of separate components. Independent (logically linked) small sized video films are connected with each other by an interface. Use of a component software allows to simplify the process of video guide composition. In this case it's no need to create and mount a full-sized film at once, containing all set of information portions, interesting for all viewer. A number of small sized video films (film portions, modules) may be created separately and then, during the process of viewing the required video material would be completed on viewer's request.

To sum up, different video guides can on option address fully or partly to the same set of modules. Video films (modules) can be divided into episodes (portions), each set of episodes can be regarded as one of the versions of the film. As mentioned above, these film portions are controlled by scripts. Scripts may be created either in connection with visual items, or with events and episodes of the entire film. Every episode is operated by a separate script, whereas playback of the whole video guide is realized by controlling the composing episodes. A viewer has the ability to view only episodes, interesting just for him. The viewer is to choose the certain script controlling playback of the particular episode from the script list. Episodes can be composed by commands in scripts as well as by operator's commands during the episodes playback. Episodes can contain panoramic viewing of the photographed place as well as moving in the chosen direction to the preset goal.

Video guides system administration tools may take into account the whole preliminary history of a viewer's motion about episodes. This can influence further viewer's actions. For example, if a viewer is noticed to pass one route two or more times, on the next turn he would be presented more detailed description of the same items then previously. Markers on the screen or functional keys on a keyboard, allowing to change the direction of movement in key points, can work as a viewer's interface. The interface may be realized as an auxiliary area, containing links (references), available from current episode, as well as a hot button, activating logic map of available episodes and links therebetween, composing the whole film. Episodes at the logic map are composed into blocks. Every block consists of top level episode and the lower blocks episodes, logically interconnected. Every block reflects the particular theme (item). Since video guide operating system takes into account the whole preliminary history of viewer's movements, viewer's interface has the corresponding area, depicting the history of modules names and/or images and previously chosen or activated items.

The technical result of the present invention comprises the video and/or audio and/or graphical and/or other multimedia information control abilities increase. The said technical result is achieved by an area assignment in the demonstration medium (the screen or some other device), adapted for a logical linking with an external application of any type, and/or with an object in the demonstrated multimedia application and/or with one or more external interfaces, and/or adapted to act being not linked with any item in the demonstrated multimedia application (i.e. it may exist and act independently from the demonstrated application). Parameters (size, shape etc.) of the assigned area may be changed according to a preliminarily assigned rule and/or may be changed during application execution by an external command.

### BRIEF DESCRIPTION OF THE DRAWINGS

FIG. 1 illustrates the correspondence formation between multimedia application and assigned area.

FIG. 2 illustrates the assigned area formation device.

FIG. 3 illustrates the assigned area formation method.

### DETAILED DESCRIPTION OF THE INVENTION

The patent RU No. 2212709 (A METHOD FOR OBJECT-ORIENTED PROCESSING OF VIDEO INFORMATION) has been chosen as a closest prior art. The invention comprises a method of multimedia information control in the presence of a multimedia application executed via demonstration of information on a demonstration medium (the screen in the case of video information) in the form of consecutive portions or as an uninterrupted stream. One or more areas are assigned in the demonstration medium. If the medium is a screen, the assigned area is formed by a closed broken line or closed curve, defined by any appropriate means. For example, a polygon is defined by the coordinates of its vertices, a circle is defined by the coordinates of its centre and its radius size or by other methods, or by a combination of methods. If the demonstration medium does not have a graphical representation (for instance, in the case of audio applications), the assigned area is defined as a set of parameters, an interval of parameters, a group of parameters (one, two or N-dimensional). An example of an area designation for an audio application could be

1) a sound of a defined pitch (a note), a set of sounds (a chord), a defined sequence of sounds or chords;

2) a defined melody tempo;

3) a defined melody rhythm;

4) the volume;

5) the tinge of sound (the type of instrument).

Other parameters can also be used.

If the demonstrated application includes audio applications with visual effects, video and/or graphical application, the area assignment can be performed in the audio demonstration medium and/or video demonstration medium and can contain audio and/or graphical parameters and/or parameters of video application. The assigned area may be adapted for accepting viewer's commands and/or may be logically linked with an external application of any type or an external interface.

The link between the assigned area and one or more external applications or interfaces, can be either simple—without additional parameters, or complicated—with one or more conditions and/or with a set of additional parameters. The link can be organized as a set of operations (rules) in a form of script describing the application execution and alteration of their spatial and/or parametric characteristics. Activation of operation may arise from the events combination taking place in the video application, from viewer's interference, from commands in the script, from other events and/or factors.

The interface as presumed here is a tool for additional processing of the commands received in connection with the assigned area and direction thereof to the external applications. An interface may possess a set of properties, a part of which are mandatory features thereof, the other are optional. An interface is placed into the multimedia application or in a separate file or in an external data storage means separately from the multimedia application. Frequently used operations and logical links can be stored in a particular library.

The present invention comprises a multimedia data processing system, a demonstration medium, a viewer's command input device, at least one external application or an interface.

The area for the viewer's command input from an input device and/or for linking with at least one external application and/or with an item of multimedia application is assigned in the demonstration medium.

The present invention also comprises a method for the assigned area contours forming, imitating in the demonstration medium the shape of the object of a compound shape demonstrated in the of video or graphic image.

According to the first version the assigned area is defined by at least one piecewise smooth curve, each separate stretches length and curvature thereof is selected to achieve the best coincidence with the contours of the imitated object.

According to the second version the assigned area is defined by the arc stretches, each separate stretches length and curvature thereof is selected to achieve the best coincidence with the shape of imitated object, the adjacent arcs in junctions can have smooth or non-smooth transition.

More than two arcs can be connected in one point. The defining of the assigned area by each stretches curvature and length selection and/or by the selection of a set of arc stretches may be done as manually, with applying of the known tools, or in semi-automatic or automatic modes.

A method for area definition on video image as a polygon, assembled from a set of rectangles is known in the art (patent RU No. 2212709). The shape of an object can be imitated with the prescribed accuracy by the variance of rectangles parameters and amount thereof.

The serious increase of the required hardware resource requiring for the increase of the accuracy in coincidence of an object shape is the main shortcoming of the method.

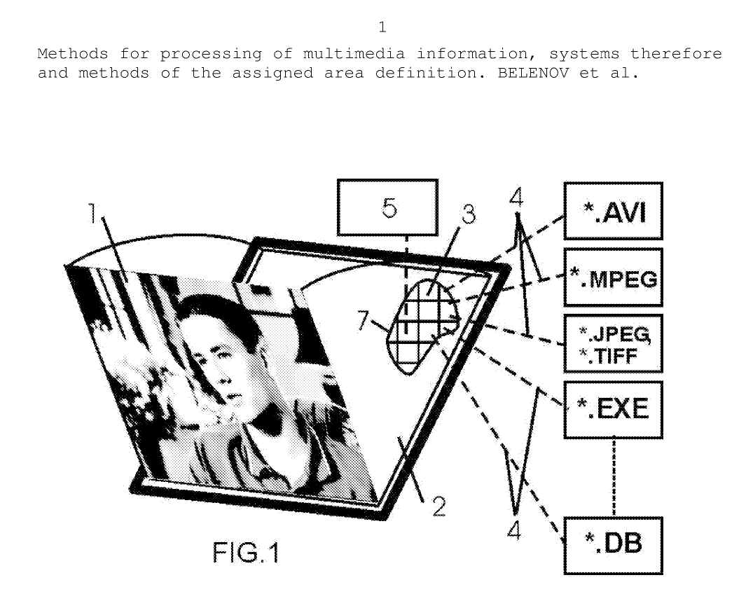

The essence of the present invention as method is illustrated by the video image on FIGS. 1-3.

The multimedia application (1) (video application) is displayed in the demonstration medium (2) (particularly on a screen) (FIG. 1). The assigned area is defined by setting of the contour parameters (7) of any required shape in the demonstration medium (2). A logic link (4) is established between the assigned area and a viewer's command input device. A logic link is also established on option between the assigned area and an external application of any type—a video application, an audio application, graphic image, an executed application of other type—a computer program, a database etc. A logic link is also established on option between the assigned area and an area at video image, a link may be established between the assigned area and any area of any size, situated anywhere on video image or a plurality of like areas simultaneously.

A spatially parametric link of the assigned area with any area at video image can be also established on option.

Logic and a spatially parametric links with a plurality of areas of video image and a link between assigned areas can also be set.

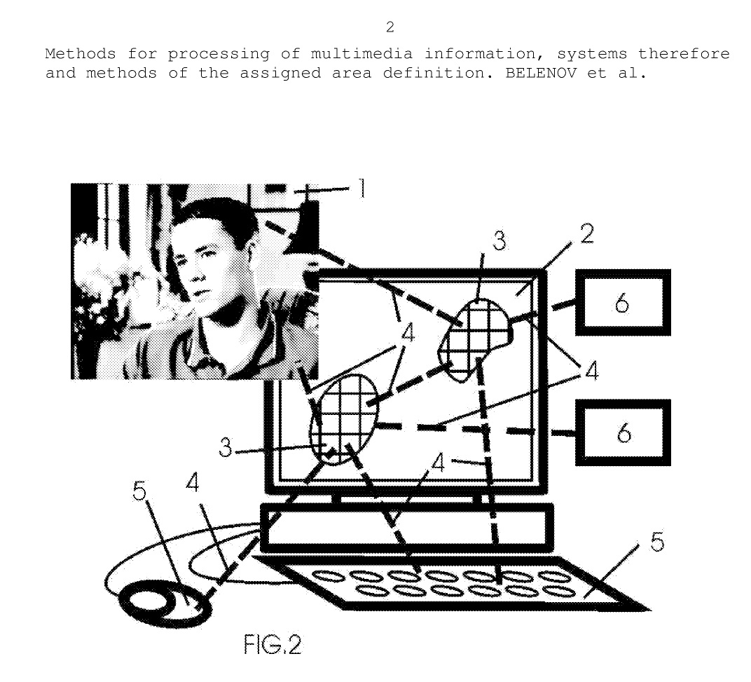

The nature of the area definition is illustrated with reference to the video device on FIG. 2. The device consists of a computer device (9) on the base of computer, a viewer's command input device (5) (for example, a keyboard, a “mouse”, a joystick etc.), a multimedia demonstration device (video, audio, graphic etc.)(2).

One or more assigned closed areas (3) linked with an external application or a device of any type, controlled by a computer (9), are formed on the demonstration device (2) by means of borders coordinates' setting thereon. The link is established between the assigned area (3) and an external application or device of any type, controlled by a computer (9). A logic and/or spatially parametric link (4) is established between the assigned area and the whole video image or a part thereof. A logic link (4) is established between the assigned area (3) and one or more external applications or a device (6) controlled by a computer (9). A logic and/or spatial-parametric link (4) is established with other assigned areas (3).

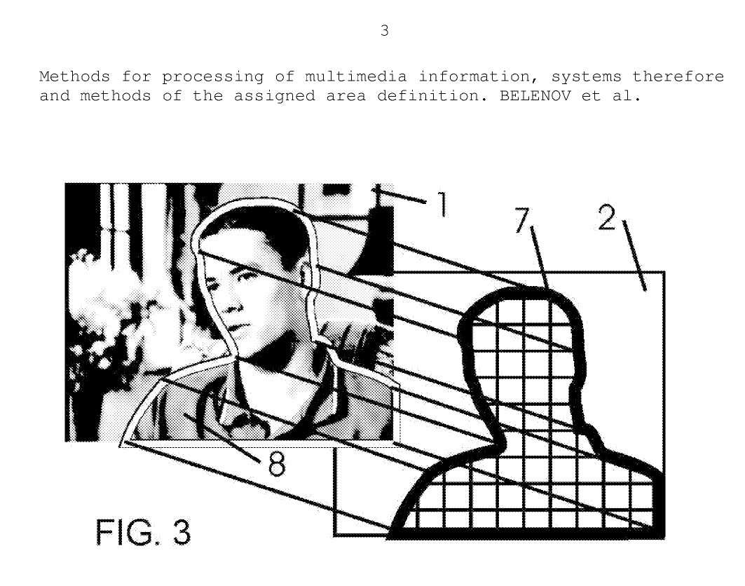

The nature of the method of the assigned area forming is illustrated on FIG. 3 for a video image as an example. An object or an arbitrary area (8) is chosen in the video image, said area is to be connected, if necessary, with one or more external objects or applications or the like. An area (3) is formed in the demonstration medium (2) said area imitates the object (8) in location and, on option, in shape.

The type of area formation method depends on the shape of the chosen object or area. If the shape of the object or the area can be defined as a polygon (with acceptable accuracy), the polygon-type area is chosen. If the shape of the object can be defined as a circle or an ellipse, the circle- or ellipse-type area is chosen, respectively.

In a case of more complicated object shape, the assigned area is formed by units imitating polygons or ellipses (or circles). For the better shape and size approximation of the assigned area to the parameters of the selected area with a little increase of hardware resources, the assigned area is formed as a set of arcs, of different curvature and length, forming the closed contour, imitating on the demonstration medium, the selected area or object chosen on the video image. Several arcs may join in one point.

Logic links between the assigned area and the video image, between the assigned area and an external application, between the assigned areas can be of a simple type and of a complex type. A complex link consists of several simple links. Besides, complex logic links can form scripts with the complex logic structure. The interconnections control between multimedia fragments is realized by simple commands, complex commands, by scripts and/or by viewer's interference.

1. A method of multimedia information processing, comprising
a multimedia information demonstrated by means of executing multimedia application, on the demonstration medium in the form of consecutive portions or in the form of an uninterrupted stream;
establishing logic links between demonstrated application and at least one external application;
receiving operator's commands during the application execution;
assignment of at least one area in demonstration medium for receiving viewer's commands during the demonstration of multimedia information and/or for establishing logic link with at least one external application and/or for establishing logic link with information of the currently executed application and/or for placing therein the external application information and/or for placing therein the results of work of the external application and/or for performing logic transition therebetween;
activating of at least one logic link between the assigned area and the preliminarily assigned object or an external application by the operator's command during the application execution and/or from the preliminarily created script.

2. The method, as recited in claim 1, where the assigned area has the form of a mathematic polygon.

3. The method, as recited in claim 1, where the spatial parameters of the assigned area are assigned in the demonstration medium by coordinates of polygon's vertices.

4. The method, as recited in claim 1, where the assigned area can be logically connected with the currently demonstrated multimedia information.

5. The method, as recited in claim 3, where the link is set between the assigned area and an area of any size and shape, situated anywhere else in the same video image.

6. The method, as recited in claim 1, where the assigned area is defined as a set of parameters or a range thereof.

7. The method, as recited in claim 1, where the logic and or spatially parametric link is established between the assigned area and at least one different assigned area.

8. The method, as recited in claim 7, where the link is established between a plurality of different assigned areas simultaneously.

9. The method, as recited in claim 1, where the assigned area for audio applications may contain all or the part of the following set of parameters:
a sound of a defined pitch and/or
a set of sounds and/or
a sequence of sounds and/or
a melody rhythm and/or
volume and/or
a tingle of sound.

10. The method, as recited in claim 1, where the assigned area is logically linked with the information of the external multimedia application not currently demonstrated.

11. The method, as recited in claim 1, where the assigned area is logically connected with information or an application of any type.

12. The method, as recited in claim 1, where the assigned area is logically connected with one or more external applications through an interface.

13. The method, as recited in claim 1, where all the information, concerning parameters of the assigned area, or a part thereof is stored in an auxiliary file.

14. The method, as recited in claim 13, where there is a strong interconnection between the contents of the currently demonstrated file and the information recorded in an auxiliary file.

15. The method, as recited in claim 1, where all information, concerning the parameters of the assigned area, or a part thereof is recorded in the currently demonstrated file.

16. The method, as recited in claim 1, where the whole assigned area or a part thereof is formed by a piecewise smooth curve or a smooth curve.

17. The method, as recited in claim 1, where the assigned area is a circle-shaped.

18. The method, as recited in claim 1, where a multimedia application of any type is placed into the assigned area.

19. The method, as recited in claim 1, where the executed application work results of any type are placed into the assigned area.

20. The method, as recited in claim 1, where a multimedia application of any type or an interface is activated in connection with the assigned area.

21. The method, as recited in claim 1, where the assigned area is supplied with the means, allowing changes of spatial and/or parametric characteristics and/or logic links thereof, according to the preliminarily assigned rule.

22. A system of multimedia information processing, comprising:
a demonstration medium for demonstration of multimedia application and/or results of work thereof and/or multimedia information;
at least one multimedia application for demonstration on the demonstration medium;
an external application and/or an external device, controlled by an external application;
operator's commands input device;
a preliminarily assigned area on the demonstration medium for establishing of at least one logic link with the external application and/or with an element of the multimedia application and/or with the device, controlled by an external application and/or for commands input from the input device.

23. The system as recited in claim 22, further comprising means for establishing a link between the currently demonstrated application and the assigned area.

24. The system as recited in claim 22, further comprising establishing a link between an external interface and the assigned area.

25. The system as recited in claim 22, further comprising establishing a link between an external application and a device or an assigned area.

26. A method of forming an assigned area in the demonstration medium, tracing the contours object image of a complex shape displayed in a video or graphic image, comprising:
the object on the demonstrated video image or on the graphic image, to be traced by the assigned area,
the assigned area contour is formed by at least one piecewise arc or arc stretches said arc stretchers, having different length, said arc or arc stretchers, having different curvature of parts thereof, to achieve the best coincidence with the contours of the traced subject.

27. The method as recited in claim 26 where adjacent arcs have smooth or non-smooth transition therebetween.

28. The method as recited in claim 26 where more than two arcs are joined in one point.

29. The method as recited in claim 26 where the assigned area is formed automatically.
